(19) United States
(12) Patent Application Publication
(10) Pub. No.: US 2005/0092146 A1
(43) Pub. Date: May 5, 2005

(54) Method and apparatus for removing material from a moving substrate

(75) Inventors: Henry Louis Carbone II, St. Paul, MN (US); John Michael Conrad, Greenville, WI (US); Andrew Edward Neubauer, Menasha, WI (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/697,448

(22) Filed: Oct. 29, 2003

(51) Int. Cl. B26D 3/00

(52) U.S. Cl. 83/13

(57) ABSTRACT

Disclosed is a method for removing material from a high speed, moving substrate. This method includes the steps of: supplying a moving substrate having at least one first portion and at least one second portion, providing a cutter and using the cutter to substantially sever the first portion from the second portion, nipping the first portion between a movable mechanical finger and a movable complementary surface, and moving the second portion away from the first portion while the first portion is maintained in contact between the movable mechanical finger and the movable complementary surface.

### BACKGROUND

In the manufacture of various products, there is a need to cut a substrate moving at high speed into separate portions and then separate the portions. For example, the production of disposable absorbent articles typically involves removing a trim portion from a product portion when shaping the product. The trim portion is cut from the substrate leaving the product portion to continue along the process path. The trim portion must be directed away from the path of the product portion to aid processing. However, the high rate of speed can make trim removal a complicated process. The process is further complicated in the situations where the trim portion to be removed is a discrete piece instead of a continuous web of material. Another complication arises when the trim portion to be removed is not completely cut free from the product portion. In such a situation, the trim removal equipment must be capable of tearing the partially severed trim loose from the product portion.

Various systems have been developed in an effort to effectively remove trim from a substrate moving at high speeds. These include the use of blowers that use compressed air to direct the trim portion away from the product portion. Vacuum removal is another means of removing a trim portion. The disadvantages of these systems include: loose trim flying around the machinery, high costs of compressed air and vacuum, the difficulty in removing incompletely severed pieces of trim, and the noise associated with compressed air and vacuum systems. Other systems attempting to address trim removal and the problem of incompletely severed trim use mechanical agitation or otherwise add energy to the substrate to remove the trim portion. For example, a spring-loaded projection can drag along the product and trim portions in an effort to dislodge the piece of trim. Another example is a counter rotating wheel or belt that applies a force to the substrate web to dislodge the trim portion. These systems address the problem of removing partially cut trim, but have the disadvantage of putting drag on the product portion of the substrate and potentially disturbing the product portion of the web. Excessive drag on the substrate can cause guiding issues and increases the potential for web breaks. Also, increasing drag can actually damage the product portion.

A potential solution to minimize product disruption is using a timed removal system that contacts only the trim portion and does not disturb the product portion. These timed removal devices can include brushes and driven rolls. One approach uses a roll at some angle, 45 degrees for example, to the substrate running at a higher velocity than the substrate. The trim portion is pulled free when the roll contacts the trim. The disadvantages of this system include the excessive energy that is being added to the substrate via the driven roll resulting in disruption of the substrate and potential guiding problems. The disruption is further aggravated with incompletely severed trim portions that are “jerked” loose from the substrate. The lack of positive control over the trim material is also a problem once the trim is severed.

For at least these reasons, there is a need or desire for a method of trim removal using positive control over the trim piece while minimizing disruption to the substrate and minimizing additional energy being added to the substrate.

### SUMMARY

In response to the discussed difficulties and problems encountered previously, the present invention provides a method for removing material from a high speed, moving substrate. An embodiment of this method includes the steps of: supplying a moving substrate having at least one first portion and at least one second portion, providing a cutter and using the cutter to substantially sever the first portion from the second portion, nipping the first portion between a movable mechanical finger and a movable complementary surface, and moving the second portion away from the first portion while the first portion is maintained in contact between the movable mechanical finger and the movable complementary surface.

In various embodiments of the invention, the first portion of the moving substrate and the second portion of the moving substrate can be either a trim portion or a product portion. For example, the first portion can be a trim portion and the second portion can be a product portion. In a second example, the first portion can be a product portion and the second portion can be a trim portion. In a third example, the first portion can be a first product portion and the second portion can be a second product portion. In embodiments including a trim portion, the trim portion can be at least one continuous web, at least one discrete piece, or combinations thereof.

The various embodiments can further include the step of directing the trim portion towards a trim transporter. The order of the steps in the present invention may vary. For example, the severing step can occur essentially simultaneously with the nipping step.

The cutter used may be any suitable cutter capable of substantially severing the substrate. For example, the cutter may be one or more of the following: a saw cutter, shear cutter, laser cutter, gas cutter, water cutter, ultrasonic cutter, arc cutter, interference cutter and combinations thereof. In some embodiments, the severing step may result in an incomplete cut. In these situations, the moving step may further include the step of tearing the first portion from the second portion at the incomplete cut. The incomplete cut may result in more than one point of connection remaining between the first portion and the second portion after the severing step. In one embodiment, the points of connection are torn apart sequentially as the second portion moves away from the first portion.

In various embodiments, the movable complementary surface can be any suitable working surface. For example, the movable complementary surface can be at least one second mechanical finger, a belt, or a rotatable anvil roll. When the movable complementary surface is a rotatable anvil roll, the cutter can be a rotatable knife roll and the rotatable anvil roll can have an outer surface with at least one recess configured to receive the mechanical finger during the nipping step. Similarly, the rotatable knife roll can have an outer surface with at least one recess configured to receive the mechanical finger before the nipping step. In these embodiments, the outer surfaces of either the rotatable knife roll or the outer surface of the rotatable anvil roll or both may have a surface speed that is essentially the same as the speed of the mechanical finger.

In another example, the cutter can be a rotatable knife roll and the movable complementary surface can be the same rotatable knife roll. In this embodiment, the rotatable knife roll can have an outer surface with at least one recess configured to receive the mechanical finger during the nipping step. Also, this embodiment may include a rotatable anvil roll with an outer surface having at least one recess configured to receive the mechanical finger before the nipping step. The outer surface of either the rotatable knife roll or the rotatable anvil or both can have a surface speed that is essentially the same as the speed of the mechanical finger.

In a third example, the movable complementary surface can be a belt. In a fourth example, the movable complementary surface can be a movable ultrasonic anvil roll and the cutter can be an ultrasonic horn. In a variation of this example, the movable complementary surface can be the same rotatable ultrasonic horn roll used as the cutter.

The present invention also includes an apparatus for removing material from a substrate moving at a high speed. This apparatus includes a cutter adapted to substantially sever a moving substrate having at least one first portion and at least one second portion; a movable complementary surface; and at least one movable mechanical finger configured to contact the first portion of the moving substrate and work in coordination with the complementary surface to nip the first portion as the second portion moves away from the first portion.

The present invention further provides a method of removing material from a high speed moving substrate while minimizing disruption to the substrate. This method includes the steps of: substantially severing a high speed moving substrate into at least one first portion and at least one second portion as the substrate moves along a substrate path; contacting the first portion with at least one movable mechanical finger; nipping the first portion between the movable mechanical finger and a movable complementary surface; maintaining the first portion under positive control; and separating the second portion from the first portion as the second portion continues along the substrate path while maintaining essentially the same speed between the two portions at the point of separation.

The present invention yet further provides a method of removing material from a high speed moving substrate using primarily the energy from the moving substrate to effect the removal. This method includes the steps of substantially severing a moving substrate into at least one first portion and at least one second portion as the substrate moves along a substrate path, wherein the substrate has a web energy; contacting the first portion with at least one movable mechanical finger; nipping the first portion between the movable mechanical finger and a movable complementary surface; maintaining the first portion under positive control; and separating the second portion from the first portion using primarily the web energy.

### FIGURES

FIG. 1 is an illustration of one embodiment of the present invention.

FIG. 2 is an illustration of one embodiment of the present invention.

FIG. 3 is a side illustration of one embodiment of the present invention.

FIG. 4 is a top view illustration showing the relationship of a mechanical finger in a recess in a complementary surface.

FIG. 5 is a top view illustration of a substrate in one embodiment of the present invention.

FIG. 6 is an illustration of a cutter and complementary surface with a mechanical finger in the gap.

FIG. 7 is a top view illustration with the cutter removed showing the relationship of the substrate to the mechanical fingers.

FIG. 8 is a top view illustration of a substrate in one embodiment of the present invention.

FIG. 9 is a top view illustration of a substrate in one embodiment of the present invention.

FIG. 10 is a side view illustration of one embodiment of the present invention.

FIG. 11 is a side view illustration of one embodiment of the present invention.

FIG. 12 is a side view illustration of one embodiment of the present invention.

FIG. 13 is a side view illustration of one embodiment of the present invention.

FIG. 14 is a top view illustration of a substrate in one embodiment of the present invention.

FIG. 15 is a magnified view of the substrate of FIG. 14.

FIG. 16 is a cross sectional view of FIG. 5 taken along line 16-16.

FIG. 17 is a cross sectional view of FIG. 5 taken along line 17-17.

FIG. 18 is an illustration of a substrate in one embodiment of the present invention.

### DETAILED DESCRIPTION

The present invention is directed to a method of removing material from a high speed substrate and the associated apparatus. As used herein, the term “high speed” means a substrate moving at a rate of 300 feet/min (91.44 meters/min) or faster. For example, high speed encompasses substrates moving at a rate of 400, 500, 600 up to and including several thousand feet/min. A detailed description of the method and apparatus is described below. The present invention can be used with any moving substrate. Such substrates can include a single layer material or can include composite layers of material such as those used in the manufacture of disposable articles such as training pants, swim pants, diapers, incontinence products, or other personal care or health care garments.

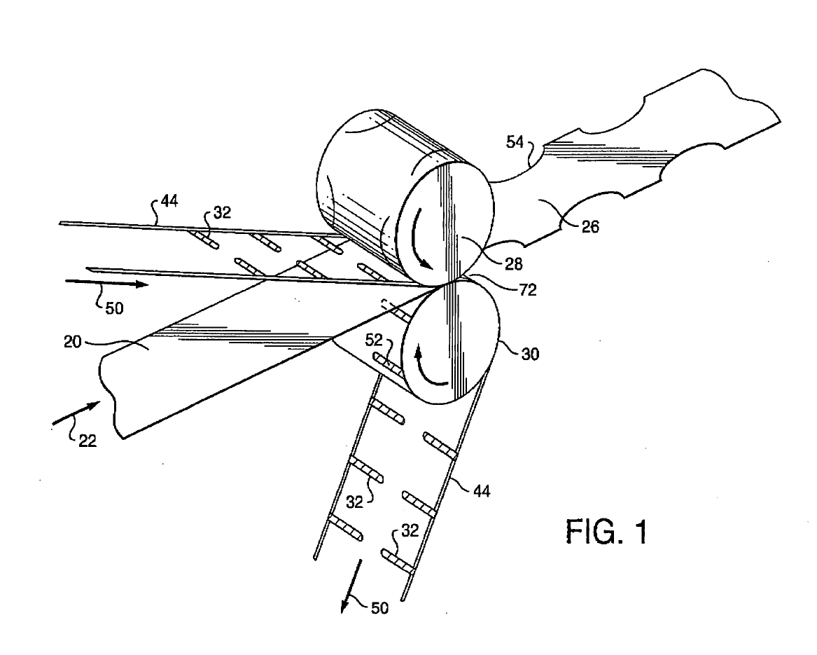

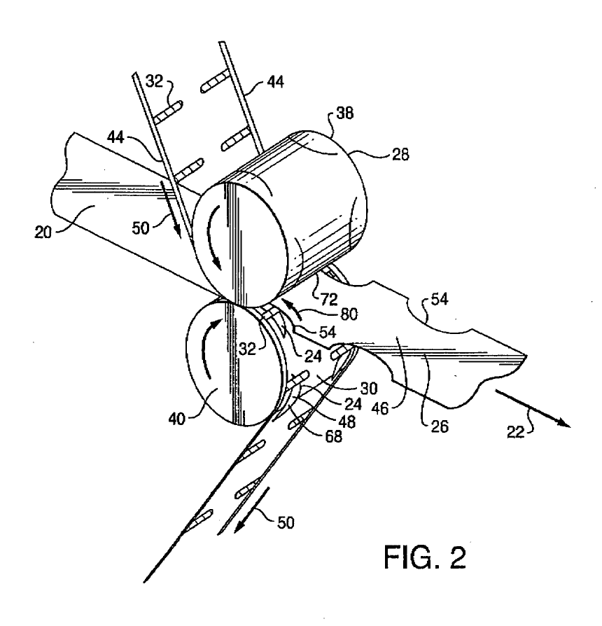

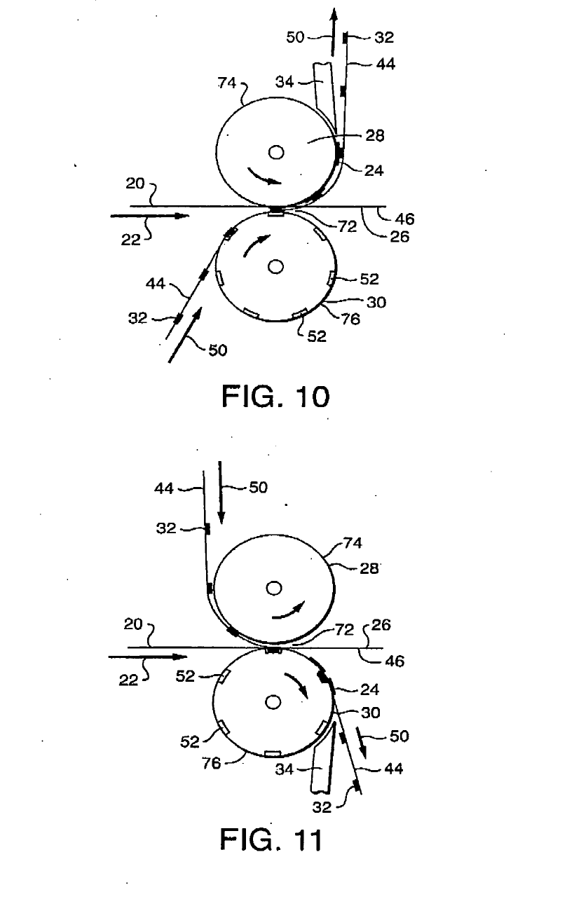

Referring to the figures and in particular FIGS. 1 and 2, the method of the present invention and associated apparatus involves providing a substrate 20 which has at least one first portion 24 and at least one second portion 26. The substrate 20 travels along a substrate path 22. FIG. 1 illustrates the substrate 20 entering a gap 72 between a cutter 28 and a complementary surface 30. FIG. 2 illustrates the substrate 20 exiting the gap 72 between the cutter 28 and the complementary surface 30. The substrate 20 passes proximate a cutter 28 which substantially severs the substrate 20 at a cut line 54 dividing the substrate 20 into at least one first portion 24 and at least one second portion 26. The first portion 24 is contacted by at least one mechanical finger 32 traveling along a finger path 50. The mechanical finger 32 nips the first portion 24 against the complementary surface 30. As used herein, the term “nip,” “nips,” or “nipping” means to contact and squeeze between two surfaces, edges, or points. The second portion 26 continues along the substrate path 22 while the first portion 24 is maintained in contact between the mechanical finger 32 and the complementary surface 30. The first portion 24 moves in the direction of the finger path 50. In various embodiments, the first portion 24 can be directed toward a trim transporter 34 after separation from the second portion 26 as illustrated in FIGS. 10-13.

As used herein, the term “substrate” means a single layer of material, a composite of two or more materials, or combinations thereof. The substrate 20 can be a substantially continuous web of material wherein each work piece is connected to the work piece immediately preceding and the work piece immediately following. The substrate 20 can also be a series of discrete work piece traveling along a transport surface such as a conveyor belt. The substrate 20 may be provided by any material or materials known to those skilled in the art that are compatible with the described mechanisms such as cutting. For example, the substrate 20 may include a nonwoven material such as a spunbond, meltblown, spun laced or carded polymeric material, a film material such as a polyolefin or polyurethane film, a foam material, cloth fabric, paper webs, foils, meshes, cellulose batts, super absorbent particles or combinations thereof. As used herein, the term “nonwoven” means a web of fibers or filaments that is formed by means other than knitting or weaving and that contains bonds between some or all of the fibers or filaments; such bonds may be formed, for example, by thermal, adhesive or mechanical means such as entanglement. A nonwoven web has a structure of individual fibers or threads that are interlaid, but not in an identifiable repeating manner. The substrate 20 may also be elastic or nonelastic such as films or layers of natural rubber, synthetic rubber or thermoplastic elastomeric polymers. As used herein, the terms “elastomeric” or “elastic” refer to any material that, upon application of a biasing force, is capable of being elongated or stretched in a specified direction from at least about 20 percent to about 400 percent or more and that will recover to within at least from about 5 to about 35 percent of its original length after being elongated or stretched. When the substrate 20 includes more than one layer of material, the layers may be the same material or may be different materials.

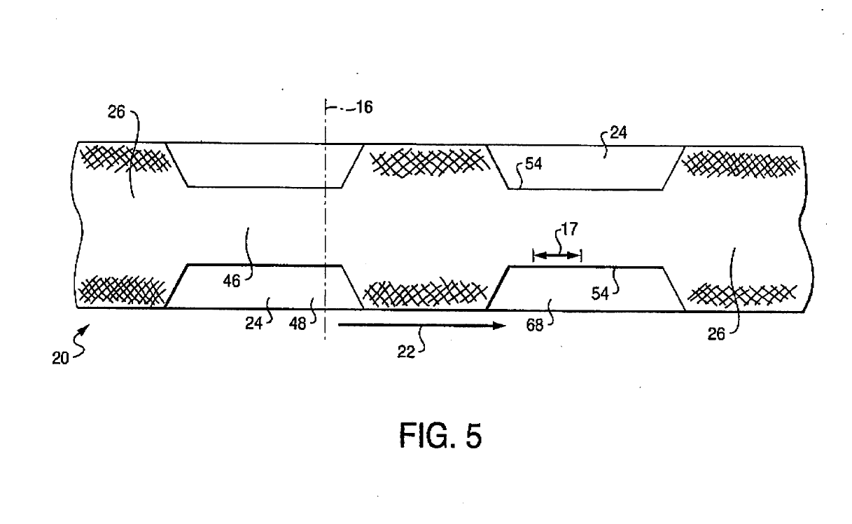

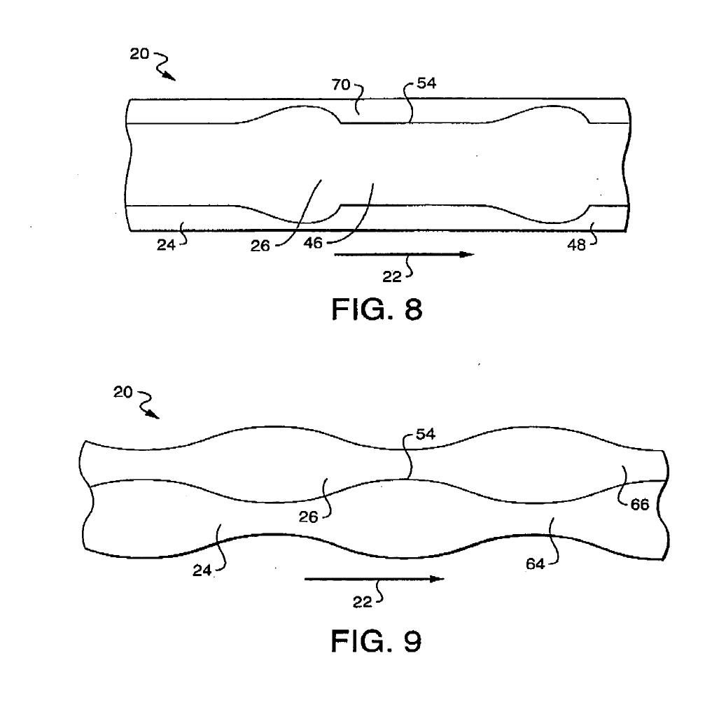

The method of the present invention can have various embodiments. For example, the first portion 24 can be either a product portion 46 or a trim portion 48. In some embodiments, the second portion 26 can be either the product portion 46 or the trim portion 48. In other embodiments, the first portion 24 may be a first product portion 64 and the second portion 26 can be a second product portion 66 as illustrated in FIG. 9. Furthermore, the first portion 24 can be either a discrete portion 68 as illustrated in FIGS. 2 and 5 or the first portion 24 can be a continuous portion 70 as illustrated in FIG. 8. In the production of absorbent articles, it may be suitable for the first portion 24 to be the trim portion 48 and the second portion 24 to be the product portion 46. For example, the product portion 46 can be a composite of liner, absorbent, and impermeable backsheet and the trim portion 48 can be a composite of liner and impermeable backsheet wherein the cut line 54 determines the shape of a leg opening on a disposable absorbent product.

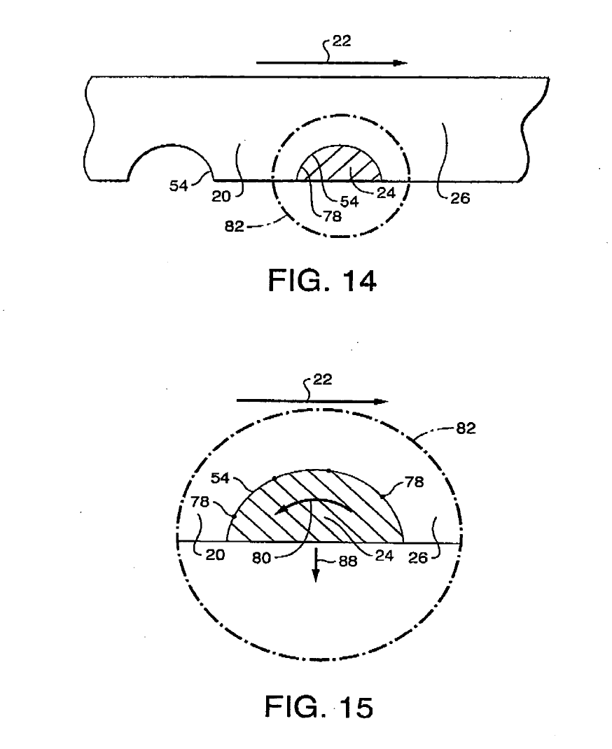

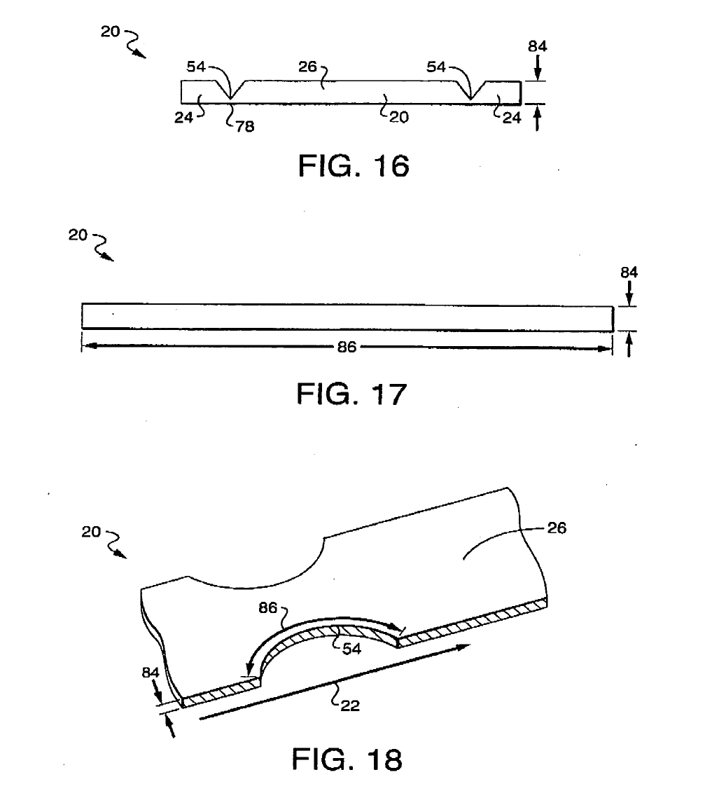

As discussed above, the various portions are substantially severed utilizing a cutter. The cutter 28 can be a saw cutter, shear cutter, laser cutter, gas cutter, water cutter, arc cutter, ultrasonic cutter, interference cutter or other suitable cutters capable of substantially severing the substrate and combinations thereof. As used herein, the term “substantially sever” means to cut through 50% or more of the substrate 20. Cutting through 50% or more of the substrate 20 includes “scoring” the substrate wherein the cut line 54 extends through 50% or more of a substrate thickness 84 as illustrated in FIG. 16 which is a cross-sectional illustration along the line 16-16 of FIG. 5. “Substantially sever” can also include cutting 50% or more of the area defined by a cut line length 86 multiplied times the substrate thickness 84 as illustrated in FIG. 17, which is a cross-sectional illustration of the line 17-17 of FIG. 5. FIG. 18 representatively illustrates a perspective view of the area defined by a cut line length 86 multiplied times the substrate thickness 84. “Substantially sever” can also include combinations of scoring and cutting through 100% of the substrate thickness 84. The cut line 54 can be complete or incomplete. As used herein, an “incomplete cut” results when the first portion 24 is not completely separated from the second portion 26 thus resulting in points of connection 78 as representatively illustrated in FIGS. 14-16.

In one embodiment the cutter can be a rotatable knife roll 38. The knife roll can include a plurality of cutting edges rotating about a shaft. In some embodiments, the cutter 28 can be a rotatable ultrasonic cutter. Representative examples of rotatable ultrasonic horns which can be used in the present invention as cutters are described in commonly assigned U.S. Pat. No. 5,096,532 to Neuwirth et al. and U.S. Pat. No. 5,110,403 to Ehlert, which are herein incorporated by reference in their entirety.

The cutter 28 is proximate the substrate path 22 and substantially severs the substrate 20 into a first portion 24 and a second portion 26 at a cut line 54. The cut line 54 may result in an incomplete cut as previously discussed. FIG. 14 illustrates a substrate web 20 with an incomplete cut within the area designated 82. FIG. 15 illustrates a magnified illustration of the area 82. Even when there is an incomplete cut, as illustrated in FIGS. 14 and 15, the first portion 24 and the second portion 26 are desirably still separated or process problems and product defects may occur. Previous techniques addressed these problems by tearing the first portion 24 from the second portion 26 by imparting energy to the substrate 20 in an essentially perpendicular direction indicated by arrow 88 as illustrated in FIG. 15. Tearing in the direction 88 can result in a “jerk” to the substrate 20 as the points of connection 78 break at essentially the same time. Imparting energy to the substrate 20 in the direction 88 and breaking the points of connection 78 at essentially the same time also results in greater impulse to the substrate 20, disrupts the substrate 20 and temporarily diverts the substrate 20 from moving in the substrate path 22. As used herein, the term “impulse” means the change in momentum produced by a force.

The method and apparatus of the present invention can remove the first portion 24 from the second portion 26 even when an incomplete cut on cut line 54 occurs while minimizing the impulse imparted to the substrate 20. In various embodiments, the points of connection 78, which can result from an incomplete cut, are torn apart sequentially in the direction indicated by arrow 80 as the second portion 26 moves away from the first portion 24 as illustrated in FIGS. 2 and 15. Tearing in direction 80 is beneficial to minimize disruption to the substrate 20 by breaking the points of connection 78 one at a time in a “zippering” action generally parallel to, but opposite in direction of, the substrate path 22. It is believed that tearing the points of connection 78 sequentially in the direction 80 also minimizes process problems, minimizes product defects, and allows greater working life from the cutter 28 by tolerating incomplete cuts while accomplishing the desired material removal.

In various embodiments of the present invention, the speed of the mechanical finger 32 may be essentially the same as the surface speed of the complementary surface 30, the surface speed of the cutter 28, the speed of the substrate 20, or any combination thereof to minimize disruptions to the substrate 20. In contrast, previous trim removal techniques involved contacting the substrate 20 with objects moving faster or slower than the substrate 20 in an effort to dislodge the first portion 24 from the second portion 26 of the substrate 20. These previous techniques imparted additional energy to the web through acceleration or deceleration. In some embodiments of the present invention, the speed match minimizes the sudden acceleration or deceleration of the first portion 24 of the substrate 20 during separation from the second portion 26. In these embodiments, the substrate 20 has a web energy generated primarily from the speed and consequent momentum of the substrate 20 moving along the substrate path 22. When a complete cut has been accomplished, a sudden change in speed and/or direction of the detached first portion 24 does not impact the remaining second portion 26 of the substrate 20. However, it is believed that in situations in which incomplete cutting occurs, the sudden change in speed and/or direction of the detached first portion 24 translates energy to the substrate 20 via the points of connection 78. The addition of energy to the substrate 20 may result in guiding or registration problems farther along in the manufacturing process. In various embodiments of the present invention, the first portion 24 may be moved out of the plane of the second portion 26 without a substantial change in speed. Therefore, the energy of the substrate 20 and in particular the second portion 26 effects the breakage of the points of connection 78 due to a gradual change in direction of the first portion 24 rather than an acceleration or deceleration of the first portion 24 relative to the second portion 26.

In embodiments wherein the substrate 20 is an elastic material, reducing disruption to the substrate 20 is even more desirable. An incomplete cut on a substrate 20 made of elastic material will require the points of connection 78 to be broken prior to separation of first portion 24 from second portion 26 as discussed before. It is believed that the elastic properties of the substrate 20 further exacerbate the “jerk” of prior trim removal techniques by stretching the points of connection 78 to a greater extent before breaking. The resulting “snap-back” of the substrate 20 after separation imparts excess energy into the substrate and may lead to registration or guiding problems. The present invention minimizes the snap-back by sequentially breaking the points of connection 78 in an essentially parallel, but opposite direction 80, to the substrate path 22. In various embodiments wherein the speed of the mechanical finger 32 is essentially the same as the speed of the substrate 20, the speed of the cutter 28, the speed of the complementary surface 30, and combinations thereof, the snap-back is further minimized.

The present invention produces similar benefits in embodiments wherein the substrate 20 is dimensionally unstable. As used herein, the term “dimensionally unstable” means the material is generally unbonded and not coherent or is only partially coherent. Examples of dimensionally unstable substrates include airlaid fibrous batts made of wood pulp fluff, nonwoven fibers, and other fibers capable of forming a loosely bonded web, and combinations thereof. In embodiments utilizing a dimensionally unstable substrate 20, support on a carrier sheet, forming wire or drum may be desirable. Examples of carrier sheets can include spunbond webs or tissue sheets. In addition, a vacuum may be pulled through the web if so desired to further contain the fibrous web. A dimensionally unstable material may also include materials that deform upon application of force and either do not recover, do not recover fully, or do not recover within the remaining processing period. As used herein, the term “recover” refers to a contraction of a stretched material upon termination of a biasing force following deformation of the material by application of the biasing force. For example, a dimensionally unstable material may contract at least about 50%, at least about 25%, or at least about 0% of the additional deformed length within 2 minutes after termination of a biasing force. As used herein, the term “processing period” refers to the time it takes for a specific portion of substrate 20 to travel through the remaining process. In high speed applications such as those compatible with the present invention, the processing period can be 2 minutes or less. For example, the processing period may be less than 1 minute, or less than 30 seconds, or less than 5 seconds, or less than ½ second. As used herein, the term “remaining process” can include the process from raw material to packaging or can include the process necessary to accomplish the method of the present invention.

Removing a first portion 24 from a second portion 26 of a dimensionally unstable substrate 20 may create increased process difficulties. These difficulties are compounded when an incomplete cut along the cut line 54 results in remaining points of connection 78. The points of connection 78 are broken during separation of first portion 24 from second portion 26 as discussed previously. However, the dimensionally unstable substrate 20 is less able to tolerate a “jerk” as prior techniques required. The force required to break all the points of connection 78 at essentially the same time is more likely to deform the dimensionally unstable substrate 20. It is believed that the present invention minimizes the deformation by sequentially breaking the points of connection 78 in an essentially parallel, but opposite direction 80, to the substrate path 22. In various embodiments wherein the speed of the mechanical finger 32 is essentially the same as the speed of the substrate 20, the speed of the cutter 28, the speed of the complementary surface 30, and combinations thereof, the deformation of the dimensionally unstable substrate 20 is further minimized. In such embodiments, the energy of the moving substrate 20 is primarily used to separate the second portion 26 from the first portion 24 as the first portion 24 is moved out of the plane of the substrate 20.

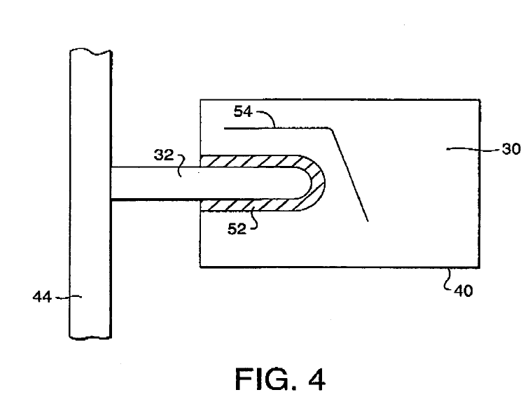

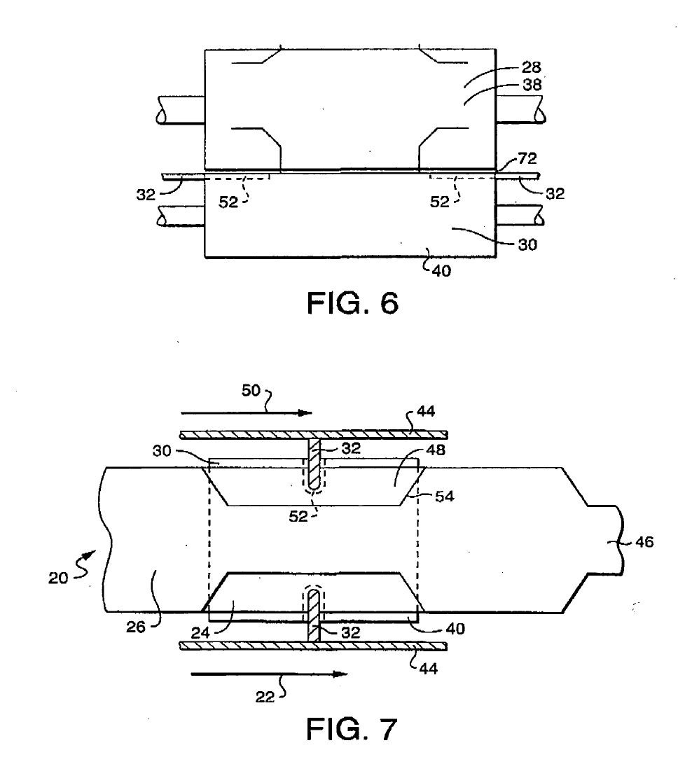

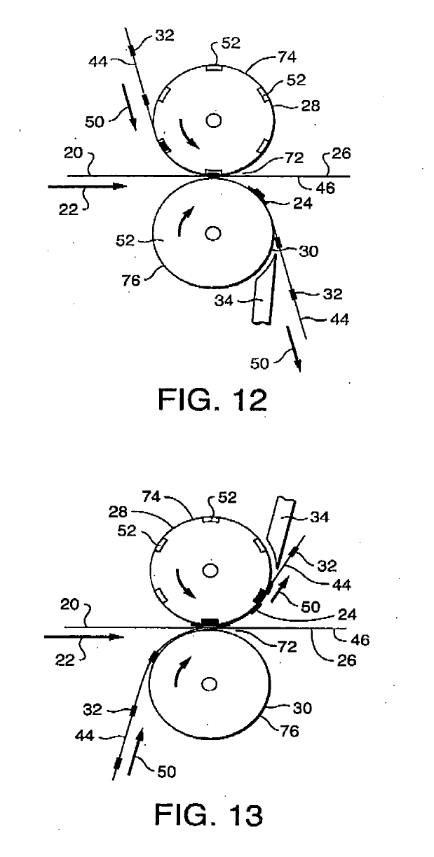

The movable mechanical finger 32 works in cooperation with the complementary surface 30. The mechanical finger 32 can be made of any suitable material providing the rigidity and durability necessary to effect the nipping process required by the method of the present invention. For example, the mechanical fingers 32 can be made of any suitable material such as, for example, plastic, metal, glass, polymer or other material capable of working in cooperation with the complementary surface 30. Referring to FIG. 1, there can be a plurality of movable mechanical fingers 32 or a single movable mechanical finger 32. The mechanical fingers may be attached to a finger transporter 44 or may be moved as a robot. As used herein, the term “robot” means a device that automatically performs complicated, often repetitive tasks and encompasses a mechanism guided by automatic controls. The finger transporter 44 can be a belt or chain or other suitable object capable of transporting the movable mechanical fingers 32. The finger transporter 44 and the attached movable mechanical fingers 32 move in the finger path 50. In various aspects of the present invention, a single finger transporter 44 can be utilized or more than one finger transporter 44 can be utilized as illustrated in FIGS. 1 and 2. In some embodiments, the movable mechanical fingers 32 pass through the gap 72 as illustrated in FIGS. 1, 2, 3, 6, 10-13. The gap 72 may be created by orienting the cutter 28 in close proximity to the complementary surface 30. The complementary surface 30 can have an outer complementary peripheral surface 76 and the cutter 28 can have a cutter peripheral surface 74. In order to facilitate passage of the movable mechanical finger 32 through the gap 72, one or more recesses 52 can be configured to receive the mechanical finger 32. As used herein, “recess” means an indentation or cleft in the outer complementary peripheral surface 76 or cutter peripheral surface 74 that is adapted to fully or partially receive at least a portion of the associated mechanical finger 32. The recesses 52 can receive the movable mechanical fingers 32 before the gap 72, at the gap 72, after the gap 72 or combinations thereof. As illustrated in FIGS. 10 and 11, the complementary surface 30 can have an outer complementary peripheral surface 76 with one or more recesses 52 therein. In other embodiments, the cutter 28 can have an outer cutter peripheral surface 74 with one or more recesses 52 therein, as illustrated in FIGS. 12 and 13. In yet other embodiments, both the cutter peripheral surface 74 and complementary peripheral surface 76 can have recesses 52 therein. FIG. 4 representatively illustrates a top view of a recess 52 receiving a mechanical finger 32 in one embodiment of the present invention.

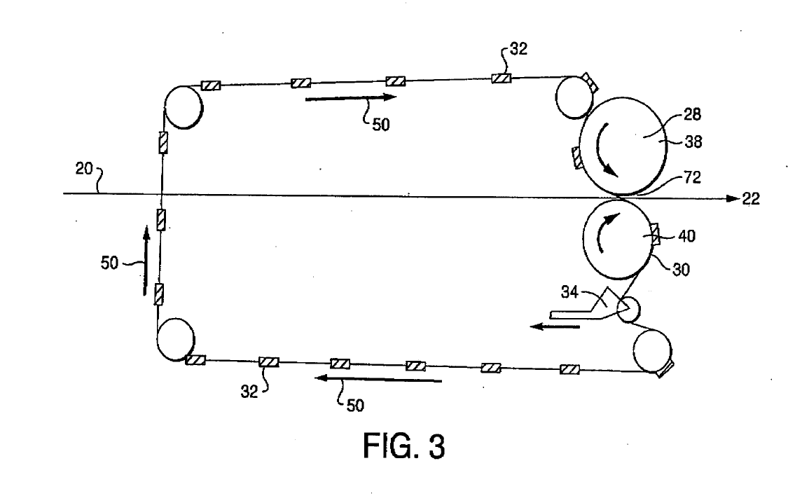

The movable complementary surface 30 can be any suitable surface capable of acting in coordination with movable mechanical finger 32. For example, the movable complementary surface 30 can be an anvil roll 40 as illustrated in FIG. 3. The movable complementary surface 30 can also be a belt, a roll, a plate, a second mechanical finger or the cutter 28 as illustrated in FIGS. 10 and 11. The movable complementary surface 30 can be made of any suitable material such as, for example, steel, rubber, silicone, plastic, nylon, tungsten carbide, super chromium, or other material capable of acting in coordination with the movable mechanical finger 32.

Referring now to FIGS. 10-13, various embodiments of the present invention are illustrated. In FIG. 10, the cutter 28 is proximate the complementary surface 30. The substrate 20 passes between the cutter 28 and the complementary surface 30 along the substrate path 22. The movable mechanical fingers 32 are attached to the finger transporter 44 and move along the finger path 50. The complementary surface 30 has recesses 52 disposed about the complementary peripheral surface 76. The recesses 52 are configured to accept the movable mechanical fingers 32. In this embodiment, the movable mechanical fingers 32 engage the recesses 52 before nipping the first portion 24 against the cutter 28 at approximately the gap 72. The mechanical finger 32 exits the recess 52 and remains in positive contact with the first portion 24 as the second portion 26 continues along the substrate path 22. The first portion 24 moves in the direction of the finger path 50 and, in various embodiments, can be directed towards a trim transporter 34.

A variation of this embodiment is illustrated in FIG. 11. In this embodiment, the cutter 28 is proximate the complementary surface 30. The substrate 20 passes between the cutter 28 and the complementary surface 30 along the substrate path 22. The movable mechanical fingers 32 are attached to the finger transporter 44 and move along the finger path 50. The complementary surface 30 has recesses 52 disposed about the complementary peripheral surface 76. The recesses 52 are configured to accept the movable mechanical fingers 32. However, in this embodiment, the movable mechanical finger 32 engages the first portion 24 before nipping the first portion 24 against the complementary surface 30 at the recess 52. Alternatively, the movable mechanical finger 32 can engage the first portion 24 at essentially the same time the movable mechanical finger 32 nips the first portion 24 against the complementary surface 30. After the nipping step, the first portion 24 remains in positive contact between the movable mechanical finger 32 and the complementary surface 30 while the second portion 26 continues along the substrate path 22. The first portion 24 moves in the direction of the finger path 50 and, in various embodiments, can be directed towards a trim transporter 34.

Another variation is illustrated in FIG. 12. The cutter 28 is again proximate the complementary surface 30. The substrate 20 passes between the cutter 28 and the complementary surface 30 along the substrate path 22. The movable mechanical fingers 32 are attached to the finger transporter 44 and move along the finger path 50. The cutter 28 has recesses 52 disposed about the cutter peripheral surface 74. The recesses 52 are configured to accept the movable mechanical fingers 32. In this embodiment, the movable mechanical fingers 32 engage the recesses 52 before nipping the first portion 24 against the complementary surface 30 at approximately the gap 72. Alternatively, the movable mechanical finger 32 can engage the recess 52 at essentially the same time as the movable mechanical finger 32 engages the first portion 24. The mechanical finger 32 exits the recess 52 and nips the first portion 24 against the complementary surface 30 and maintains positive contact with the first portion 24 as the second portion 26 continues along the substrate path 22. The first portion 24 moves in the direction of the finger path 50 and, in various embodiments, can be directed towards a trim transporter 34.

Yet another variation is illustrated in FIG. 13. In this embodiment, the cutter 28 is proximate the complementary surface 30. The substrate 20 passes between the cutter 28 and the complementary surface 30 along the substrate path 22. The movable mechanical fingers 32 are attached to the finger transporter 44 and move along the finger path 50. The cutter 28 has recesses 52 disposed about the cutter peripheral surface 74. The recesses 52 are configured to accept the movable mechanical fingers 32. However, in this embodiment, the movable mechanical finger 32 engages the first portion 24 before nipping the first portion 24 against the cutter 28 at the recess 52. Alternatively, the movable mechanical finger 32 can engage the first portion 24 at essentially the same time the movable mechanical finger 32 nips the first portion 24 against the cutter 28. After the nipping step, the first portion 24 remains in positive contact between the movable mechanical finger 32 and the cutter 28 while the second portion 26 continues along the substrate path 22. The first portion 24 moves in the direction of the finger path 50 and, in various embodiments, can be directed towards a trim transporter 34.

The present invention also includes an apparatus for removing material from a high speed moving substrate 20. FIG. 3 is a side view illustration of one embodiment of the apparatus of the present invention. The apparatus includes a cutter 28 adapted to substantially sever a moving substrate 20 into at least one first portion 24 and at least one second portion 26. The apparatus also includes at least one movable mechanical finger 32 configured to contact the first portion 24 of the moving substrate 20. The movable mechanical finger works in cooperation with a movable complementary surface 30. The movable mechanical finger 32 is configured to nip the first portion 24 against the movable complementary surface 30 as the second portion 26 moves away from the first portion 24. FIG. 7 representatively illustrates a top view of the movable mechanical finger 32 contacting the first portion 24 as the substrate 20 moves along substrate path 22. The cutter 28 is not shown in FIG. 7 to better illustrate the relative positions of the movable mechanical finger 32 and the complementary surface 30 in one embodiment of the present invention.

In various embodiments, the complementary surface 30 may be an anvil roll. For example, the cutter 28 may be a rotatable knife roll 38 and the complementary surface 30 can be a rotatable anvil roll 40 as illustrated in FIGS. 1, 2, and 6. In another example, the cutter 28 may be a rotatable ultrasonic horn roll and the complementary surface 30 may be a rotatable ultrasonic anvil roll. In other embodiments, the complementary surface 30 may be the cutter 28. For example, the cutter 28 could be a rotatable knife roll or a rotatable ultrasonic horn roll and can function as the complementary surface 30. In yet other embodiments, the complementary surface 30 may be at least one second movable mechanical finger. The complementary surface 30 may also be a belt or any other surface capable of forming a nip with the movable mechanical finger 32.

The apparatus of the present invention may further include a finger transporter 44.

In embodiments consisting of a finger transporter 44, the movable mechanical fingers 32 are attached to the finger transporter 44 by any suitable means. For example, the mechanical fingers 32 can be a unitary portion of the finger transporter 44 or can be attached with bolts, welds, adhesive, thermal bonds, or any other suitable attachment device or combinations thereof. The finger transporter 44 can move along a finger path 50 by means of rolls, pulleys, sprockets, gears, bearings or other means capable of directing the finger transporter 44.

The apparatus may further include a trim transporter 34 capable of moving the trim portion 48 away from the complementary surface 30. The trim transporter 34 can include a vacuum chute, belt, conveyor, entrained air stream, or other transport means capable of moving the trim portion 48 away from the complementary surface 30, or combinations thereof.

While the invention has been described in detail with respect to specific embodiments thereof, it will be appreciated that those skilled in the art, upon attaining an understanding of the foregoing, may readily conceive of alterations to, variations of and equivalents to these embodiments. Accordingly, the scope of the present invention should be assessed as that of the appended claims and any equivalents thereto.

1. A method for removing material from a high speed, moving substrate, comprising:
supplying a moving substrate having at least one first portion and at least one second portion;
substantially severing the first portion from the second portion utilizing a cutter;
nipping the first portion between a movable mechanical finger and a movable complementary surface; and
moving the second portion away from the first portion while the first portion is maintained in contact between the movable mechanical finger and the movable complementary surface.

2. The method of claim 1 wherein the first portion Is a trim portion and the second portion is a product portion.

3. The method of claim 2 wherein the trim portion is at least one continuous web.

4. The method of claim 2 wherein the trim portion is at least one discrete piece.

5. The method of claim 2 further comprising the step of directing the trim portion towards a trim transporter.

6. The method of claim 1 wherein the first portion is a product portion and the second portion is a trim portion.

7. The method of claim 1 wherein the first portion is a first product portion and the second portion is a second product portion.

8. The method of claim 1 wherein the severing step results in an incomplete cut and the moving step includes tearing the first portion from the second portion at the incomplete cut.

9. The method of claim 8 wherein the incomplete cut results in more than one point of connection remaining between the first portion and the second portion, and wherein the points of connections are tom apart sequentially as the second portion moves away from the first portion.

10. The method of claim 1 wherein the severing step occurs essentially simultaneously with the nipping step.

11. The method of claim 1 wherein the cutter is selected from the group consisting of saw cutter, shear cutter, laser cutter, gas cutter, water cutter, ultrasonic cutter, arc cutter, interference cutter and combinations thereof.

12. The method of claim 1 wherein the movable complementary surface is at least one second mechanical finger.

13. The method of claim 1 wherein the cutter is a rotatable knife roll and the movable complementary surface is a rotatable anvil roll.

14. The method of claim 13 wherein the rotatable anvil roll has an outer surface having at least one recess configured to receive the mechanical finger during the nipping step.

15. The method of claim 13 wherein the rotatable knife roll has an outer surface having at least one recess configured to receive the mechanical finger before the nipping step.

16. The method of claim 14 wherein the outer surface has a surface speed and the mechanical finger has a finger speed essentially the same as the surface speed.

17. The method of claim 15 wherein the outer surface has a surface speed and the mechanical finger has a finger speed essentially the same as the surface speed.

18. The method of claim 1 wherein the cutter is a rotatable knife roll and the movable complementary surface Is the rotatable knife roll.

19. The method of claim 18 wherein the rotatable knife roll has an outer surface having at least one recess configured to receive the mechanical finger during the nipping step.

20. The method of claim 18 further comprising an anvil roll having an outer surface with at least one recess configured to receive the mechanical finger before the nipping step.

21. The method of claim 19 wherein the outer surface has a surface speed and the mechanical finger has a finger speed essentially the same as the surface speed.

22. The method of claim 20 wherein the outer surface has a surface speed and the mechanical finger has a finger speed essentially the same as the surface speed.

23. The method of claim 1 wherein the movable complementary surface is a belt.

24. The method of claim 1 wherein the cutter is an ultrasonic horn and the movable complementary surface is a movable ultrasonic anvil roll.

25. The method of claim 1 wherein the cutter Is a rotatable ultrasonic horn roll and the movable complementary surface is the rotatable ultrasonic horn roll.

26. An apparatus for removing material from a high speed moving substrate comprising:
a cutter adapted to substantially sever a moving substrate Into at least one first portion and at least one second portion;
a movable complementary surface; and
at least one movable mechanical finger configured to contact the first portion of the moving substrate and wherein the movable mechanical finger Is configured to nip the first portion in coordination with the movable complementary surface as the second portion moves away from the first portion.

27. A method of removing material from a high speed moving substrate while minimizing disruption to the substrate, comprising the steps of:
substantially severing a moving substrate into at least one first portion and at least one second portion as the substrate moves along a substrate path;
contacting the first portion with at least one movable mechanical finger;
nipping the first portion between the movable mechanical finger and a movable complementary surface;
maintaining the first portion under positive control; and
separating the second portion from the first portion as the second portion continues along the substrate path.

28. A method of removing material from a moving substrate using primarily the energy from the moving substrate, comprising the steps of:
substantially severing a moving substrate Into at least one first portion and at least one second portion as the substrate moves along a substrate path, wherein the substrate has a web energy;
contacting the first portion with at least one movable mechanical finger;
nipping the first portion between the movable mechanical finger and a movable complementary surface;
maintaining the first portion under positive control; and
separating the second portion from the first portion using primarily the web energy.
